(19) United States
(12) Patent Application Publication
(10) Pub. No.: US 2018/0019703 A1
(43) Pub. Date: Jan. 18, 2018

(54) WIRE CLIP FOR PHOTOVOLTAIC MODULES

(71) Applicant: SolarCity Corporation, San Mateo, CA (US)

(72) Inventors: Charles Bernardo Almy, Berkeley, CA (US); Brian Despard West, Larkspur, CA (US)

(21) Appl. No.: 15/211,188

(22) Filed: Jul. 15, 2016

(51) Int. Cl. H02S 40/36; H02G 3/02; H02S 30/10

(52) U.S. Cl. CPC H02S 40/36; H02S 30/10; H02G 3/02

(57) ABSTRACT

Disclosed is a wire clip for securing wires to a flange of a photovoltaic module frame. The wire clip includes a base having a first end and a second end. The first end of the base is opposite the second end. The wire clip also includes an attachment arm extending from and cooperating with the base to define an opening that faces the first end and that leads into a frame-receiving slot. A wire gather extends from the base and defines an opening that faces the second end and that leads into a wire-receiving slot. The wire gather extends from a portion of the base closer to the second end than the first end.

### BACKGROUND

Photovoltaic modules are generally interconnected serially so that electricity generated by the photovoltaic modules can be routed to a circuit breaker and/or other electrical component for subsequent distribution of the electricity. The wires can also be used to send instructions to and gather information from the photovoltaic modules and/or module-based electronics. Mounting hardware commonly used to route these wires can be difficult to install and hard to use. For example, wire clips that are conventionally used to manage in a photovoltaic (PV) array rely upon discrete mounting points or channel features on a photovoltaic module frame to achieve a robust installation. These mounting points can be difficult to locate and can substantially reduce the flexibility installers have when routing these wires. For these reasons an improved wire clip is desirable.

### SUMMARY

This disclosure describes various embodiments that relate to a wire clip for securing wires under a photovoltaic array.

A wire clip suitable for attachment to a photovoltaic module frame is disclosed. The wire clip includes a base having a first surface and a second surface opposite the first surface. An attachment arm extends from the first surface and cooperates with the base to define a slot sized to receive a portion of a photovoltaic module frame. The wire clip also includes a wire gather extending from the second surface and cooperating with the base to define an interior volume sized to receive a number of wires. A hook is formed at a distal end of the base. The hook and an end of the attachment arm define an opening configured to receive the portion of the photovoltaic module frame.

In some embodiments, the wire gather and the attachment arm cooperate to define an S-shaped geometry.

In some embodiments the attachment arm is configured to support a number of wires disposed within the wire gather and the weight of the wire clip when the wire clip is attached to a photovoltaic module frame.

In some embodiments, the end of the attachment arm includes a lip oriented away from the base of the wire clip that biases the photovoltaic module frame into the slot.

In some embodiments, the wire clip includes a wire-receiving channel configured to guide wires into the wire gather.

In some embodiments, the wire-receiving channel is defined by a first tapered end extending from the base and a second tapered end extending from a distal end of the wire gather.

In some embodiments, the first tapered end is angularly offset from the second tapered end by an angle of between 45 and 75 degrees.

A photovoltaic module assembly is described. The photovoltaic module assembly includes a wire clip having a base and an attachment arm extending from the base. The attachment arm and base cooperate to define a frame-receiving slot. A first opening leading into the frame-receiving slot is oriented towards a first end of the base. The wire clip also includes a wire gather extending from the base and defining an internal volume. A second opening leading into the internal volume is oriented towards a second end of the base, the second end of the base being oriented opposite the first end. The photovoltaic module assembly also includes a photovoltaic module having a photovoltaic module frame. A portion of the photovoltaic module frame is positioned within the frame-receiving slot; and an electrically conductive wire is supported by the wire gather and extends through the internal volume defined by the wire gather.

In some embodiments, a first opening leading into the frame-receiving slot is oriented opposite a second opening leading into the wire gather.

In some embodiments, the photovoltaic module assembly also includes a hook at the first end of the base.

In some embodiments, the photovoltaic module also includes an array of solar cells supported by the photovoltaic module frame.

In some embodiments, the hook engages a lateral facing surface of the photovoltaic module frame.

In some embodiments, the portion of the photovoltaic module frame disposed within the frame-receiving slot is a flange portion of the photovoltaic module frame that is oriented substantially parallel with respect to the array of solar cells and substantially perpendicular with respect to the lateral facing surface of the photovoltaic module frame.

In some embodiments, the wire gather includes a stiffening rib extending from a central region of the wire gather that compresses a portion of the wire disposed within the wire gather.

In some embodiments, a diameter of the wire corresponds to a curvature of an interior surface of the wire gather.

A wire clip is described and includes a base having a first end and a second end, the first end opposite the second end. An attachment arm extends from the base and cooperates with the base to define an opening that faces the first end and leads into a frame-receiving slot. The wire gather also extends from the base and defines an opening that faces the second end and leads into a wire-receiving slot. The wire extends from a portion of the base closer to the second end than the first end.

In some embodiments, the first end of the base forms a hook.

In some embodiments, the hook is configured to resist removal of the wire clip from a photovoltaic module frame.

In some embodiments, a distal end of the attachment arm includes a lip extending away from the base that is configured to guide a portion of a photovoltaic module frame into the frame-receiving slot.

In some embodiments, the attachment arm includes a stiffening rib having a width less than half of an overall width of the attachment arm.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a perspective view of a lower side of a solar energy collection system suitable for use with the described embodiments, showing the wire clip according to various embodiments of the invention;

FIG. 2 shows a close up view of a lateral portion of the solar energy collection system depicted in FIG. 1;

FIG. 3 shows a perspective view of the wire clip depicted in FIG. 2;

FIGS. 4A-4B show side and top views, respectively of the wire clip depicted in FIG. 3;

FIGS. 5A-5D illustrate a series of installation steps for attaching the wire clip to a photovoltaic module frame;

FIG. 6 shows an alternative wire clip embodiment having a large wire gather portion; and

FIG. 7 shows a flow chart depicting steps of a method for installing the wire clip according to various embodiments of the invention.

Other aspects and advantages of the invention will become apparent from the following detailed description taken in conjunction with the accompanying drawings which illustrate, by way of example, the principles of the described embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice them, it is understood that these examples are not limiting; other embodiments may be used, and changes may be made without departing from the spirit and scope of the described embodiments.

Photovoltaic modules are often arranged in large arrays when configured to convert light from the sun into electricity in residential and commercial applications. Each photovoltaic module generally includes its own set of electrical contacts and/or ports for sending and receiving signals and for delivering power to other components such as junction boxes, energy storage units, and even adjacent photovoltaic modules. The power generated by the solar cells of the photovoltaic modules generally flows along wires attached to terminals of each photovoltaic module. This can result in an array of photovoltaic modules having two or more wires running throughout the array of photovoltaic modules. One way to keep these wires off of the roof, ground or other support surface, and from interfering with general operations of the array is to attach the wires to certain portions along the array using a number of wire clips. Unfortunately, conventional wire clips are often hard to install on account of needing to be engaged with particular mounting points defined by a photovoltaic module frame. This can force installers to have to search for particular attachment points for the wire clips, which can substantially slow down installation times. The slower installation times have many negative consequences including limiting the number of total solar system installations that can be completed by an installation team and increasing labor costs associated with any type of solar system installation involving wire clips. Homeowners and businesses having the systems installed also are disadvantaged as they are forced to schedule around the installation team.

One solution to this problem is to utilize a wire clip design that snaps easily into place on many different locations of the frame of a photovoltaic module and includes a wire gather defining an aperture for holding the wires that is simple and convenient to engage with one or more wires. Such a wire clip should be able to snap into place in a large number of location on a photovoltaic module frame because it does not rely upon a discrete feature for attachment. Instead, the wire clip can instead be configured to attach anywhere along one or more sides of a photovoltaic module frame. The aperture of the wire gather can be sized to be compatible with a large number of wire types, thereby increasing the flexibility of the wire clip. Furthermore, a design of the wire clip can be scaled or elongated for attachment to a wide variety of photovoltaic module frame sizes.

The wire clip can also have an S-shaped geometry defined by the wire gather and a frame slot configured to engage a flanged portion of a photovoltaic module frame. The S-shaped geometry allows the wire clip to robustly resist forces incident to the wire clip during installation of one or more wires within the wire clip. Furthermore, once the wires are installed within the wire gather of the wire clip, static forces exerted by the wires on the wire clip are opposed by virtue of the forces pushing the frame slot against the photovoltaic module frame. Consequently, installers can exert substantial amounts of force on such a wire clip when engaging wires into the wire gather without having to worry about dislodging the wire clip.

The wire clip can also include a hooked end configured to engage a lateral facing surface of the photovoltaic module frame. The hooked end can slide over and around a corner of the photovoltaic module frame during installation. Because the hooked end engages an opposite side of the photovoltaic module frame from the flanged portion of the photovoltaic module frame, any forces that would otherwise tend to disengage the frame-receiving slot from the photovoltaic module frame can be directly opposed by contact between the hooked end and the opposite side of the photovoltaic module frame.

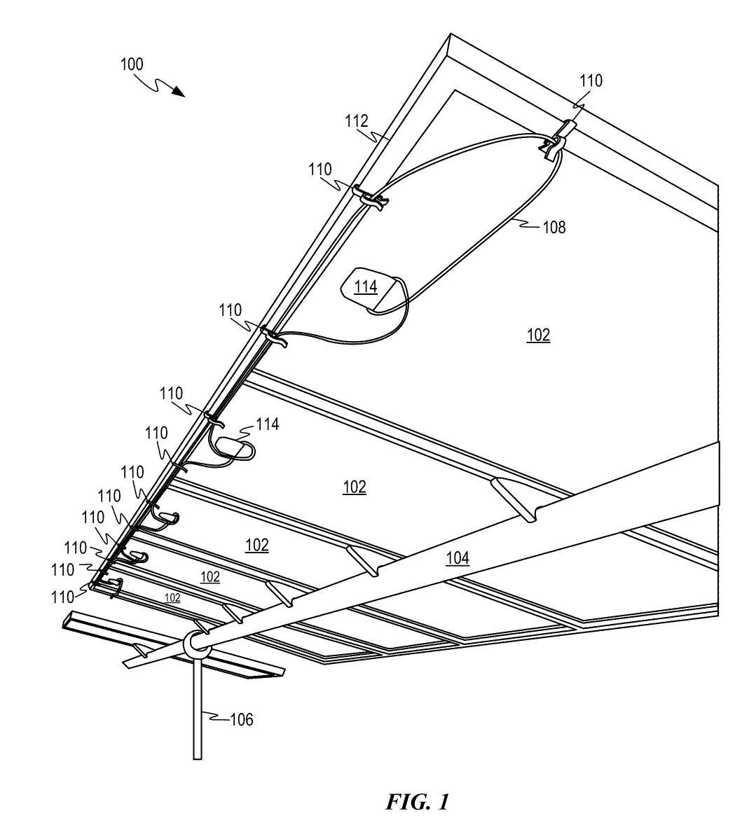

These and other embodiments are discussed below with reference to FIGS. 1-7, however, those skilled in the art will readily appreciate that the detailed description given herein with respect to these figures is for explanatory purposes only and should not be construed as limiting.

FIG. 1 shows a perspective view of solar energy collection system 100. Solar energy collection system 100 includes photovoltaic modules 102, which are depicted being supported by torque tube 104. Torque tube 104 is in turn supported above the ground by support pile 106. Support pile 106 can include a pile cap that allows torque tube 104 to rotate freely while enjoying the support of support pile 106. Torque tube 104 can be rotated at a rate that causes photovoltaic modules 102 to remain oriented towards the sun throughout the day. Energy from each of photovoltaic modules 102 can be routed to a central energy collection hub by wires 108. One way in which wires 108 can be secured to a downward facing side of photovoltaic modules 102 is by using wire clips 110 to secure wires 108 to photovoltaic module frames 112. As depicted, an average of two wire clips 110 can be attached to photovoltaic module frames 112 of each of photovoltaic modules 102. A larger or smaller number of wire clips 110 can be utilized depending on the weight and number of wires 108 being used. In some embodiments, each of wire clips 110 can be configured to receive multiple wires or multiple segments of a single wire. As depicted, most of wire clips 110 hold two portions of wire 108. In this way, photovoltaic modules 102 can each be coupled with electrical components on each side of wire 108. For example, one end of wire 108 can be coupled with a control system for adjusting the angle of photovoltaic modules 102 and the other end of wire 108 can be coupled with electrical components configured to receive power generated by photovoltaic modules 102. It should be appreciated that application of the invention is not limited to solar trackers. For example, wire clips 110 may be used on a sloped roof, flat roof, or other type of stationary ground-mounted array.

With continued reference to FIG. 1, in some embodiments, the control system can rely on signals received from photovoltaic modules to fine-tune an angular position of torque tube 104. For example, photovoltaic module 102 can be configured to send a signal indicative of how much energy photosensitive components of photovoltaic module 102 are generating to the control system. When the total energy output increases as a result of an angular change in position, the control system can be configured to keep rotating photovoltaic modules 102 in the same direction until total energy output begins to decrease again. In this way, solar energy collection system 100 can be configured to maximize energy output without any other orientation or sun-tracking sensors. It should be noted that photovoltaic modules 102 include an array of solar cells supported by photovoltaic module frame 112 as well as one or more connectors for offloading power. In some embodiments, the connectors can also be used for sending and receiving communications.

FIG. 1 also depicts junction boxes 114 arranged along a rear surface of photovoltaic modules 102. Junction boxes 114 typically contain the positive and negative leads from each PV module that are connected in series to adjacent PV modules. In some embodiments, junction boxes 114 can include a hook, loop or other shape for holding slack in wires 108. In some embodiments, junction boxes 114 can support and protect portions of wire 108 that are coupled to connectors of photovoltaic module 102. It should be noted that while wire clips 110 are depicted as being installed upon a sun-tracking photovoltaic module array that clips 110 can just as easily be installed on and efficiently used with a stationary array of photovoltaic modules. A wire clip designed to withstand the varied forces of a sun-tracking photovoltaic module array would also be able to operate effectively with a stationary array with more constant forces.

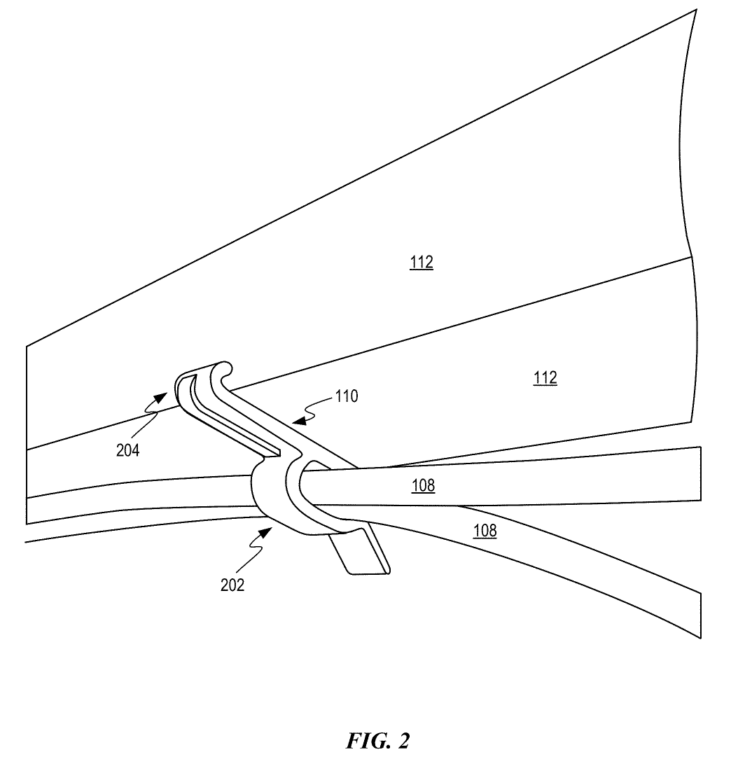

FIG. 2 shows a close-up view of a lateral portion of photovoltaic module frame 112. Wire clip 110 is depicted engaged with a lower portion of photovoltaic module frame 112. Wire gather 202 of wire clip 110 is depicted supporting two portions of wire 108. It should be appreciated that wire gather 202 could also hold multiple unrelated wires. FIG. 2 also depicts hook 204 of wire clip 110 engaging a lateral facing surface of photovoltaic module frame 112. In some embodiments, hook 204 can be designed to engage the lateral facing surface by way of an interference fit alone. In other embodiments, hook 204 can be designed to interact with a lip near the corner of photovoltaic module frame 112. In some embodiments, the primary function of hook 204 can be to oppose movement of wire clip 110 towards the center of photovoltaic module 102. In this way, hook 204 can prevent inadvertent sliding of wire clip 110 off of photovoltaic module frame 112, while still allowing clip 110 to slide laterally along the length of the module frame to a desired position. This slip opposing function can be particularly helpful when the end of photovoltaic module frame 112 that wire clip 110 is attached to is pointed nearly vertically. In such an orientation hook 204 functions to oppose any gravitational forces acting upon wire clip 110.

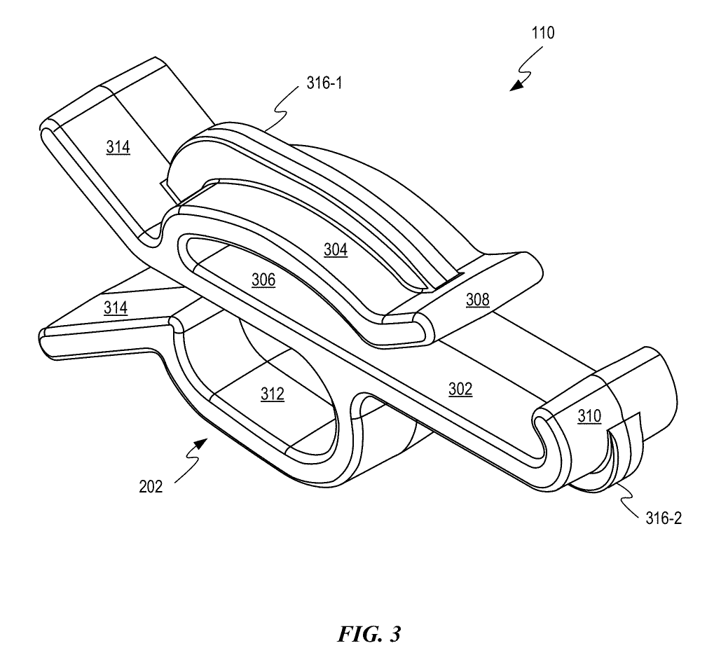

FIG. 3 shows a perspective view of wire clip 110. Wire clip 110 can be an injection-molded part made from any number of different hard plastics. Other possible materials include hard rubbers, silicone and flexible metals. In particular, FIG. 3 shows how wire clip 110 includes base 302. Attachment arm 304 protrudes from one side of base 302 and then curves back towards base 302 until it is oriented substantially parallel with base 302. Slot 306 is defined by both attachment arm 304 and base 302. Slot 306 can be sized to receive a portion of the underside of photovoltaic module frame 112. A distal end of attachment arm 304 can take the form of lip 308 that curves away from base 302, thereby increasing the size of the entrance leading into slot 306. Lip 308 can make it easier for an installer to insert a portion of photovoltaic module frame 112 within slot 306 on account of lip 308 effectively increasing the size of the opening leading into wire clip 110. Wire clip 110 also includes hook 310 extending from one end of base 302 and back towards lip 308. The portion of photovoltaic module frame 112 that fits within wire clip 110 can be received through the space between lip 308 and hook 310.

FIG. 3 also depicts how wire gather 202 extends from a side of base 302 opposite attachment arm 304. Consequently, wire gather 202 initially extends away from attachment arm 304 and then curves back towards base 302 to define internal volume 312, which is capable of receiving and supporting a number of wires or cables. In some embodiments, the material defining internal volume 312 can include one or more stiffening ribs that tend to put a small crimp in any wires passing through internal volume 312. This engagement between the stiffening rib or ribs can help to keep wires passing through internal volume 312 from sliding laterally within wire gather 202 after installation.

FIG. 3 also depicts how attachment arm 304 and wire gather 202 cooperate to make an S-shaped geometry. Wire gather 202 also includes tapered ends 314 that define a wire-receiving channel configured to guide wires into internal volume 312. Tapered ends 314 can be angularly offset from one another by between 45 and 75 degrees. FIG. 3 also depicts stiffening ribs 316-1/2. Stiffening ribs 316-1/2 help to increase the strength and sectional inertia of particular portions of wire clip 110. For example, stiffening rib 316-1 is configured to strengthen attachment arm 304, on account of it being configured to handle most of the weight of any wires held by wire clip 110. Stiffening rib 316-2 helps reinforce hook 310. Reinforcement of hook 310 can be important in situations where hook 310 is subject to substantial loading. For example, hook 310 can be responsible for supporting most of the weight from any wires positioned within internal volume 312 when the photovoltaic module to which it is attached is positioned at particular angles.

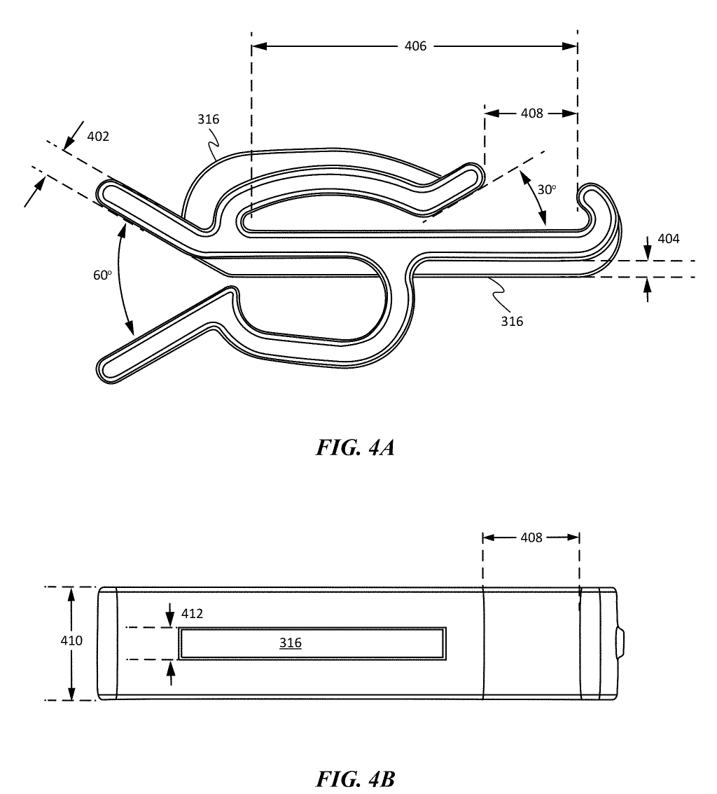

FIG. 4A shows a side view of wire clip 110. In particular, FIG. 4A helps to how relative proportions and geometries of the different features of one embodiment of wire clip 110. It should be appreciated that wire clip 110 can be scaled to many different sizes and that the dimensions given should not be construed as limiting. Thickness 402 of wire clip 110, which is fairly consistent throughout wire clip 110, can be about 3 mm. Thickness 404 of stiffening rib 316 can be about 2 mm. In this way, stiffening ribs 316 almost double the effective thickness of various portions of wire clip 110. FIG. 4A also shows how a distance 406 between a proximal end of attachment arm 304 and hook 310 can be about 35 mm while a distance 408 between a distal end of attachment arm 304 and hook 310 can be about 10 mm. Distance 406 can vary widely to account for different dimensions of photovoltaic module frame 112.

FIG. 4B shows a top view of wire clip 110. In particular, the top view shows an effective width 410 of wire clip 110. In some embodiments, effective width 410 can be about 12 mm. An effective width 412 of stiffening rib 316 can be about 3 mm or about a quarter of the overall width of wire clip 110. In some embodiments, the width of stiffening ribs 316 can be adjusted to tune wire clip 110 to handle different amounts of weight. It should be noted that while various specific dimensions are given, these measurements are given for exemplary purposes only and many other shapes and sizes should also be considered within the scope of this disclosure.

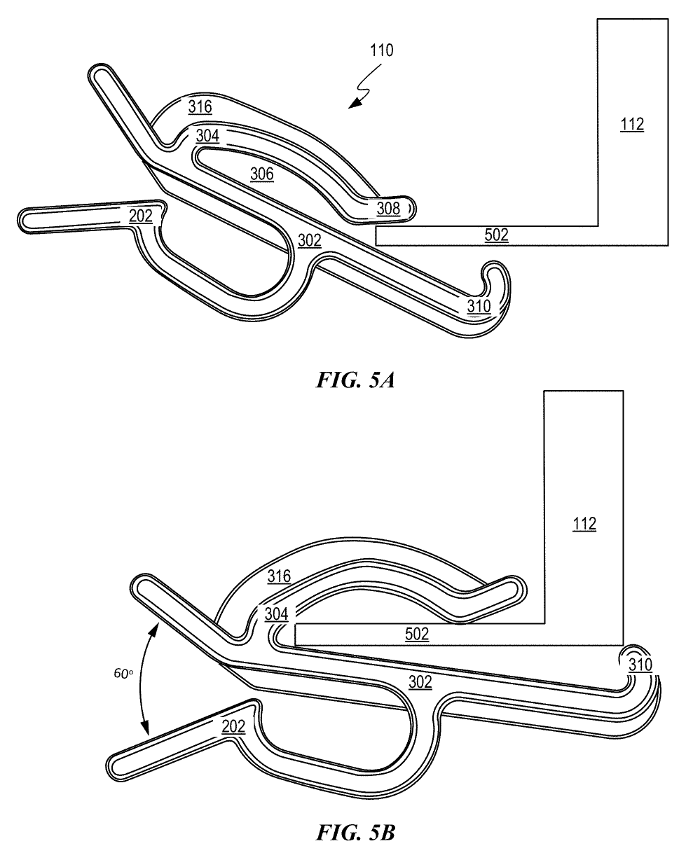

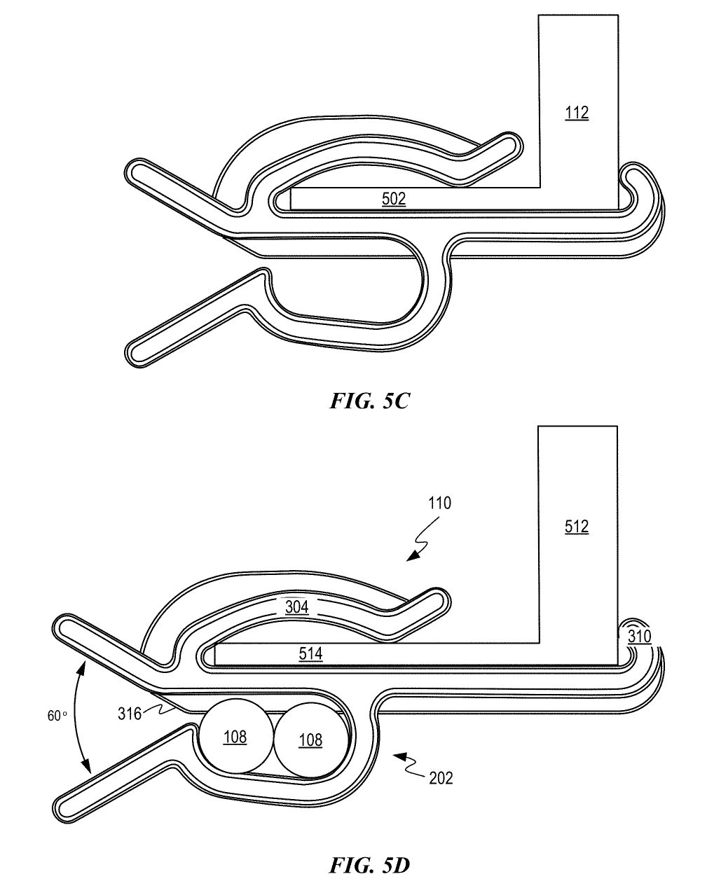

FIGS. 5A-5D illustrate a series of installation steps for attaching wire clip 110 to photovoltaic module frame 112 and adding wires 108 to wire gather 202. Wire clip 110 includes base 302, from which both attachment arm 304 and wire gather 202 protrude. Attachment arm 304 includes lip 308 at its distal end. FIG. 5A shows wire clip 110 tilted to receive flange 502 of photovoltaic module frame 112 between base 302 and attachment arm 304. FIG. 5A also illustrates how lip 308 interacts with flange 502 to guide flange 502 into slot 306. An angle of lip 308 with respect to attachment arm 304 can vary depending on the size of wire clip 110 to increase the ease with which flange 502 can be slid within slot 306.

FIG. 5B shows how attachment arm 304 bends away from base 302 as wire clip 110 is pushed farther onto photovoltaic module frame 112 and continues to bend until hook 310 passes a corner of photovoltaic module frame 112. A height and width of stiffening rib 316 can be tuned to accommodate the depicted deformation of attachment arm 304 during installation. A height of stiffening rib 316 can increase as it approaches base 302, thereby strengthening a connection between attachment arm 304 and base 302.

FIG. 5C shows how once wire clip 110 is fully installed on photovoltaic module frame 112, attachment arm 304 returns substantially to its original state. Depending on a thickness of flange 502, attachment arm 304 can remain slightly deformed to accommodate the thickness of flange 502. It should also be noted that the curvature of hook 310 prevents unexpected interaction between hook 310 and any manufacturing defects that might be present on the corner of photovoltaic module frame 112. Hook 310 is preferable over an L-shaped end on account of use of the L-shaped end resulting in wire attachment arm 110 undergoing an unexpectedly large amount of stress for a particular installation when the corner of the L-shaped end interacts with manufacturing defects that effectively increase the length of flange 502. FIG. 5C also shows how wire attachment arm 110 is sized to achieve an interference fit between attachment arm 304 and hook 310.

FIG. 5D shows an elongated embodiment of wire clip 110 and how portions of wire 108 can be positioned within wire gather 202 after attachment of wire clip 110 to photovoltaic module frame 112. When the diameter of wires 108 exceeds the size of an opening leading into wire gather 202, insertion of wires 108 into wire gather 202 can result in the portion of wire gather 202 that defines the opening deforming away from base 302 of wire clip 110. After wire 108 slides through the opening between wire gather 220 and stiffening rib 316, wire gather 202 can return to its natural position, which as depicted can keep wires 108 retained within wire gather 202 in any orientation of wire clip 110. In some embodiments, stiffening rib 316 can cause portions of wire 108 positioned within wire gather 202 to be compressed even after being fully inserted within wire gather 202. This configuration can be beneficial when it is desirable to keep wires 108 from sliding within wire gather 202. In some embodiments, wires 108 can have a diameter of between 7 and 8 mm. The interior curvature of wire gather 202 can be designed to substantially match the 7-8 mm diameter of wires 108. In this way, the available space within wire gather can be maximized. It should also be noted that FIG. 5D shows how the elongated geometry of wire clip 110 can accommodate the larger length of flange 514 of photovoltaic module frame 512.

FIG. 5D also illustrates how forces are distributed in wire clip 110 when wire clip 110 is fully installed on photovoltaic module frame 512. In the depicted horizontal orientation of photovoltaic module frame 512, wire clip 110 is supported almost exclusively by attachment arm 304. While hook 310 can generate some frictional force through its contact with an exterior facing wall of photovoltaic module frame 512 it should be appreciated that a majority of the weight of both wire clip 110 and wires 108 are supported by attachment arm 304. This is particularly true on account of wire gather 202 being arranged on the same side of wire clip 110 as attachment arm 304. The primary function of hook 310 is to prevent wire clip 110 from unintentionally sliding off of photovoltaic module frame 512. Any contribution to bearing the load exerted by wires 108 is merely incidental. It should be noted that when the distance between hook 310 and the portion of attachment arm 304 that joins base 302 is the same as or slightly smaller than the size of flange 514, frictional forces between hook 310 and the exterior facing wall of photovoltaic module frame 512 can be more likely to assist in bearing the loading exerted by wires 108.

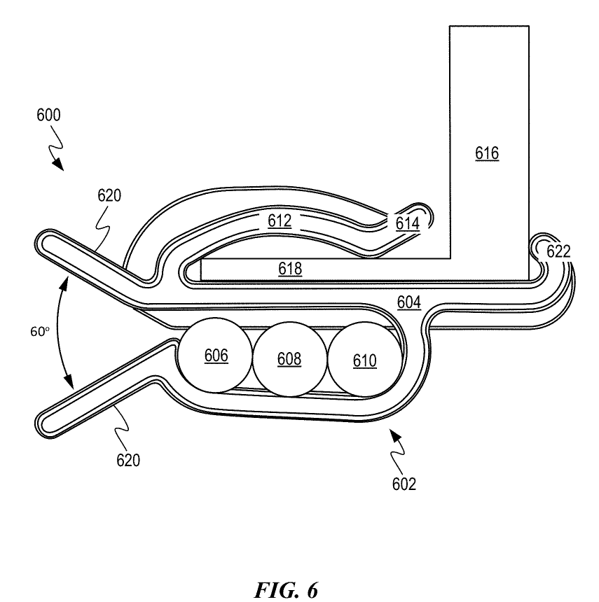

FIG. 6 shows an alternative wire clip 600 including wire gather 602 attached to photovoltaic frame 616. Wire clip 600 also includes base 604 from which wire gather 602 extends. In particular, wire gather 602 has a greater amount of space for retaining wires 606, 608 and 610 than does wire gather 202. The additional space is achieved without substantially increasing a size of wire clip 600 by shifting the attachment point of wire gather 602 with respect to base 604 in comparison to the previously depicted wire clips. This allows wire gather 602 to run along a greater length of wire clip 600 than in wire clip 110. Wire clip 600 can also include attachment arm 612, which is configured to cooperate with base 604 to engage and surround flange 618. In some embodiments, it can be advantageous to keep a center of gravity of wires 606-610 on the same side of base 610 as attachment arm 612. This allows most of the weight supported by wire clip 600 to be handled by attachment arm 612. Positioning the center of gravity of the weight of wires 606-610 near the end of wire clip 600 with hook 622 could result in hook 622 being dislodged from photovoltaic module frame 616.

Deviations from the embodiments depicted herein are possible and are considered to be within the scope of this disclosure. For example, it should be appreciated that wire gather 602 can extend down and farther away from base 604 of wire clip 600 to accommodate additional wires within wire gather 602. It should be noted that while tapered ends 620 leading into wire gather 602 define an opening angle indicated as being 60 degrees this angle can vary widely. For example, angles of between 45-75 degrees are possible and can be desirable depending on the desired wire clip size and installation difficulty. For example, where installers have to reach into a small cavity to engage the wire clip a larger angle can be desirable for ease of installation. Where installers have clear access and visibility to the wire clip a smaller angle between the tapered ends can be more desirable. In some embodiments, hooked end 622 can have a telescoping feature allowing it to change sizes to accommodate various photovoltaic module frame sizes. In some embodiments, the telescoping feature associated with hook 622 can have discrete positions it is configured to stop in that allows wire clip 600 to accommodate a number of predetermined photovoltaic module frame sizes. In addition, the various wire gathers shown herein may have a latch portion that allows the wire gather to be locked close after wires are inserted, thereby providing an additional level of security.

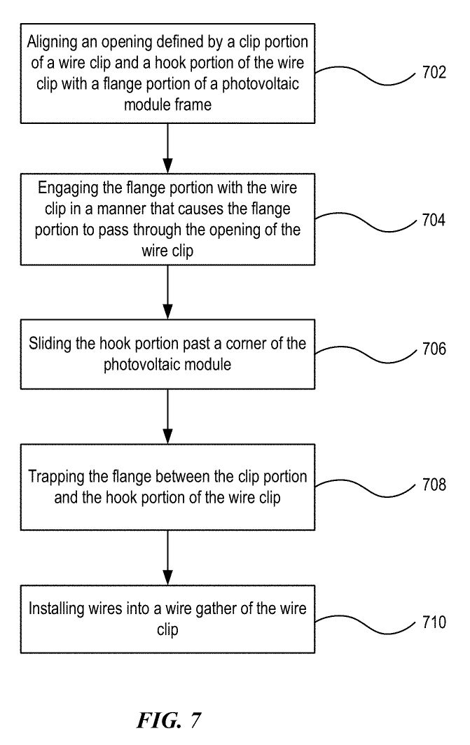

FIG. 7 shows a flow chart depicting a method for installing a wire clip according to various embodiments of the invention. At 702 an opening defined by an attachment arm portion of a wire clip and a hook portion of the wire clip is aligned with a flange portion of a photovoltaic module frame. At 704, an area between the attachment arm portion of the wire clip and a base portion of the wire clip is pushed onto the flange portion of the photovoltaic module. Positioning the flange within this area generally causes the attachment arm portion to deform away from the base portion to accommodate the geometric features of the photovoltaic module frame to which it is attached. In some embodiments, the attachment arm portion can be reinforced with a stiffening rib to help prevent the attachment arm portion from bending too much or breaking during installation as discussed and illustrated herein. At 706, deformation of the attachment arm portion allows the hook portion to slide around a corner of the photovoltaic module frame. Once the hook portion extends past the corner of the wire clip, the wire clip can return to a substantially undeformed or natural state. The curvature of the hook portion can also help avoid interaction with any defects positioned on the corner of the wire clip. In some embodiments, the hook can be shaped in different ways. For example, in some embodiments, the hook can be larger and configured to engage a channel defined by a lateral facing surface of the photovoltaic module frame.

At 708, once the wire clip is fully installed, the flange portion of the photovoltaic module frame is trapped between the attachment arm portion and the hook portion of the wire clip. At 710, wires can be inserted into a wire gather portion of the wire clip. The wire gather portion of the wire clip can extend from a surface of the base portion such that the wire gather is positioned beneath the flange portion of the photovoltaic module frame. The wire gather portion can define an opening substantially smaller than a diameter of the wires it is designed to retain. In this way, the wire gather can be configured to retain the wires within the wire gather because the wires will essentially pre-load the wire gather. In some embodiments, a structural rib can extend into an interior area defined by the wire gather, which can compress one or more wires positioned within the wire gather. This method can be repeated multiple times to install multiple wire clips around the photovoltaic module frame to help with routing supporting wiring for the photovoltaic module.

The various aspects, embodiments, implementations or features of the described embodiments can be used separately or in any combination. Various aspects of the described embodiments can be implemented by software, hardware or a combination of hardware and software. For example, in some embodiments, robotic machinery could be utilized to perform a portion of or all of an installation operation. In this way, the various installation steps described could therefore be carried out by a computing platform with instructions executed by a processor and carried out by machinery of the robotic machinery.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A wire clip suitable for attachment to a photovoltaic module frame, the wire clip comprising:
a base including a first surface and a second surface opposite the first surface;
an attachment arm extending from the first surface and cooperating with the base to define a slot sized to receive a portion of a photovoltaic module frame;
a wire gather extending from the second surface and cooperating with the base to define an interior volume sized to receive a plurality of wires; and
a hook formed at a distal end of the base, the hook and an end of the attachment arm defining an opening configured to receive the portion of the photovoltaic module frame.

2. The wire clip of claim 1, wherein the wire gather and the attachment arm cooperate to define an S-shaped geometry.

3. The wire clip of claim 1, wherein the attachment arm is configured to support a plurality of wires disposed within the wire gather and the weight of the wire clip when the wire clip is attached to a photovoltaic module frame.

4. The wire clip of claim 1, wherein the end of the attachment arm comprises a lip oriented away from the base of the wire clip that biases the photovoltaic module frame into the slot during installation.

5. The wire clip of claim 1, further comprising a wire-receiving channel configured to guide wires into the wire gather.

6. The wire clip of claim 5, wherein the wire-receiving channel is defined by a first tapered end extending from the base and a second tapered end extending from a distal end of the wire gather.

7. The wire clip of claim 6, wherein the first tapered end is angularly offset from the second tapered end by between 45 and 75 degrees.

8. A photovoltaic module assembly, comprising:
a wire clip, comprising:
a base,
an attachment arm extending from the base and defining a frame-receiving slot in cooperation with the base, a first opening leading into the frame-receiving slot oriented towards a first end of the base and
a wire gather extending from the base and defining an internal volume, a second opening leading into the internal volume being oriented towards a second end of the base, the second end opposite the first end;
a photovoltaic module, comprising a photovoltaic module frame, a portion of the photovoltaic module frame being positioned within the frame-receiving slot; and
an electrically conductive wire supported by the wire gather and extending through the internal volume defined by the wire gather.

9. The photovoltaic module assembly of claim 8, wherein a first opening leading into the frame-receiving slot is oriented opposite a second opening leading into the wire gather.

10. The photovoltaic module assembly of claim 8, further comprising a hook at the first end of the base.

11. The photovoltaic module assembly of claim 10, wherein the photovoltaic module further comprises an array of solar cells supported by the photovoltaic module frame.

12. The photovoltaic module assembly of claim 11, wherein the hook engages a lateral facing surface of the photovoltaic module frame.

13. The photovoltaic module assembly of claim 12, wherein the portion of the photovoltaic module frame disposed within the frame-receiving slot is a flange portion of the photovoltaic module frame that is oriented substantially parallel with respect to the array of solar cells and substantially perpendicular with respect to the lateral facing surface of the photovoltaic module frame.

14. The photovoltaic module assembly of claim 8, wherein the wire gather comprises a structural rib extending from a central region of the wire gather that compresses a portion of the wire disposed within the wire gather.

15. The photovoltaic module assembly of claim 8, wherein a diameter of the wire corresponds to a curvature of an interior surface of the wire gather.

16. A wire clip, comprising:
a base having a first end and a second end, the first end opposite the second end;
an attachment arm extending from and cooperating with the base to define an opening that faces the first end and leads into a frame-receiving slot; and
a wire gather extending from the base and defining an opening that faces the second end and leads into a wire-receiving slot,
wherein the wire gather extends from a portion of the base closer to the second end than the first end.

17. The wire clip of claim 16, wherein the first end of the base forms a hook.

18. The wire clip of claim 17, wherein the hook is configured to resist removal of the wire clip from a photovoltaic module frame.

19. The wire clip of claim 16, wherein a distal end of the attachment arm comprises a lip extending away from the base that is configured to guide a portion of a photovoltaic module frame into the frame-receiving slot.

20. The wire clip of claim 16, wherein the attachment arm comprises a stiffening rib having a width less than half of an overall width of the attachment arm.
